(19) United States
(12) Patent Application Publication
(10) Pub. No.: US 2008/0232731 A1
(43) Pub. Date: Sep. 25, 2008

(54) Axial bearing comprising a radially inner and a radially outer rolling-contact bearing

(76) Inventor: Gideon Daniel G. VENTER, Berlin (DE)

Correspondence Address: Harbin King & Klima, 500 Ninth Street SE, Washington, DC, 20003, US

(21) Appl. No.: 12/076,461

(22) Filed: Mar. 19, 2008

(30) Foreign Application Priority Data
Mar. 22, 2007 (DE) 10 2007 013 826.3

(51) Int. Cl. F16C 19/30

(52) U.S. Cl. 384/517

(57) ABSTRACT

An axial bearing having a radially inner 4 and a radially outer rolling-contact bearing 2, with the radially inner rolling-contact bearing 4 including an inner bearing ring 5 and a center bearing ring 3 and the radially outer rolling-contact bearing 2 including the center bearing ring 3 and an outer bearing ring 1 as well as a positive-drive element 6-10 for the center bearing ring 3.

This application claims priority to German Patent Application DE102007013826.3 filed Mar. 22, 2007, the entirety of which is incorporated by reference herein.

This invention relates to an axial bearing, and more particularly, to an axial bearing used as thrust bearing for a gas turbine.

Axial bearings, which are usually of the rolling-contact type, must be dimensioned such that they are capable of taking up the thrust axially exerted by a shaft, and more particularly, the compressor shaft or the turbine shaft of a gas turbine. For space and weight reasons, gas turbines are provided, as known from the state of the art, with a single axial bearing, with this bearing being additionally required to take up radial forces.

If this axial force, which results primarily from the thrust of the gas turbine, exceeds a certain magnitude, it is no longer transmittable via the axial bearing as the latter has achieved its performance limit. Therefore, investigations into other, expensive design solutions are to be made.

The design of existing gas turbines is accordingly constrained by the load maximally transferable by the axial support. Therefore, an increase in thrust can only be accomplished via other design measures. For example, installation of a generally larger bearing could be taken into account which, besides higher weight, would have a larger diameter. This means, however, that the overall design of the compressor and/or other components would have to be altered. In consequence, the gas turbine will increase in diameter, which is often not desired. Also, such alteration would entail higher costs. Furthermore, a change in bearing size would require modification and adaptation of the entire sealing system. The resultant demand for more sealing air would, however, have a negative effect on efficiency and fuel consumption of the gas turbine.

A simple increase in size of the axial bearing is also excluded or very strictly limited for other reasons.

The currently used bearing steels are already at the limits of material strength. Further increase is impossible or would involve considerable investment. The use of ceramic bearings similarly does not provide for the desired increase in axial force, as the size of the bearing elements is limited, in particular, by the desired speeds. Furthermore, loadability of a bearing is also limited by the centrifugal force which acts, in particular, upon the rolling elements.

Further limitations applicable to the radial dimensioning of the axial bearings, in particular the centric ducting of gas, arise from the architecture of the gas turbines. The larger the required size of the bearing arrangement is, the more forward on the gas turbine it has to be installed. This requires that the high-pressure compressor shaft must be increased in length. Such a measure will, however, affect the stiffness of the shaft and the aerodynamic conditions.

Since double-row axial bearings have not proven satisfactory on gas turbines, and more particularly, on aircraft gas turbines, they are avoided in this application and have been replaced by single-row ones. The typical problem involved with double-row bearings is, in particular, the non-uniformity of load distribution. Consequently, one bearing row or one bearing is unloaded and subjected to heavier wear. Other than in normal mechanical engineering, precise control of load distribution on multi-row bearings can in practice not be ensured on gas turbines.

The present invention provides an axial bearing which includes a radially inner and a radially outer rolling-contact bearing which feature a common center bearing ring. Thus, the axial bearing according to the present invention comprises an inner bearing ring, a center bearing ring and a radially outer bearing ring. To ensure that both bearings are uniformly loaded, a positive-drive element for the center bearing ring has been provided.

Accordingly, with the center bearing ring being positively driven, the present invention offers the advantage that both bearings are always loaded in a specified manner. Hence, both bearings will always be loaded as specified. With a suitably designed positive drive for the center bearing ring, an engineering mechanism is available which enables the load to be distributed between both bearings.

Accordingly, the present invention provides for the use of a duplex bearing or a double-row bearing in a usual installation situation of a bearing arrangement. Further design measures, in particular an increase in diameter or the like, are not required.

Here, it is particularly advantageous that both bearings are essentially concentric to each other. They can either be exactly concentric or slightly staged in the axial direction.

Other than with conventional double-row bearings, where both bearings feature a common inner ring and a common outer ring, three bearing rings are provided according to the present invention.

If the shaft with the inner bearing ring is now set into rotation, the center bearing ring will be co-rotated by the positive drive, but at different rotational speed. The outer bearing ring usually remains stationary. Without the provision of a positive drive, only one of the two bearings would be set into rotation, while the other bearing would remain at rest. This would lead to non-uniform loading, resulting in differences in service-life of the two bearings. Consequently, one of these bearings would be liable to premature wear and failure.

The present invention, therefore, provides for appropriate control of the motion of the center bearing ring. This is accomplished by the positive drive which sets both bearings in rolling motion.

The present invention accordingly offers the advantage that the effective speed of the bearing is reduced. Thus, compared with an axial bearing according to the state of the art, the number of load cycles throughout the life of the bearing is reduced. Since life and roadability of the bearing are interrelated, an increase in the bearing load is obtainable by a reduction of the operating cycles.

Furthermore, reduction of the rotational speed results in reduction of the centrifugal load exerted on the rotating parts, in particular the rolling elements. This enables larger components with higher load-carrying capacity to be used, permitting the loadability of the bearing to be further increased.

With the bearing load being distributed according to the present invention, the risk of non-uniform bearing load and non-uniform wear is avoided. Accordingly, equal lives can be expected for both bearings.

Obviously, the bearing design according to the present invention is not limited in application to gas turbines. Rather, the axial bearing can also be used in other applications where high rotational speeds occur and high axial forces are to be transmitted.

In accordance with the present invention, it is particularly favorable if the positive-drive element comprises a planetary gearing. Such planetary gearing is space-saving and highly reliable. Depending on the design of the planetary gearing, the center bearing ring can be rotated either in the direction or against the direction of shaft rotation. The latter may contribute to a reduction of centrifugal forces. It is obvious that other solutions may also be provided for the positive-drive element, for example solutions of the hydraulic or pneumatic type.

The present invention is more fully described in light of the accompanying drawing showing a preferred embodiment. In the drawing,

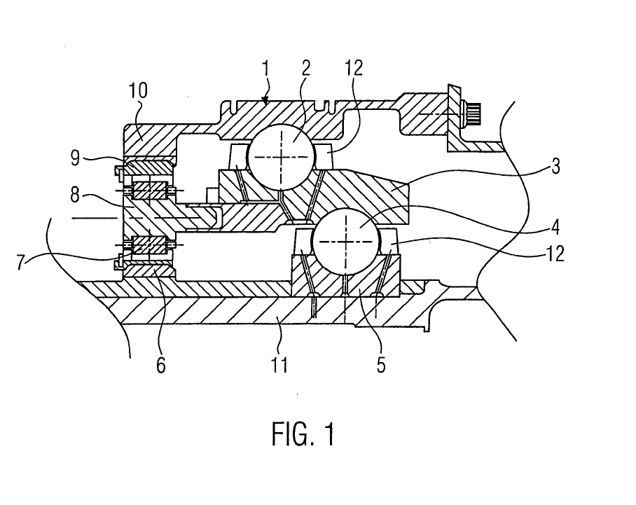

FIG. 1 is a sectional view of an axial bearing according to the present invention.

The axial bearing according to the present invention includes an outer bearing ring 1 which is non-rotationally connected to, or combined with, a bearing housing not further shown here. In accordance with the present invention, a radially outer rolling-contact bearing 2 is provided which rests on a center bearing ring 3. The latter is again part of a radially inner rolling-contact bearing 4 which comprises an inner bearing ring 5 which is anti-rotationally connected to a shaft 11.

While FIG. 1 shows a ball-bearing design of the bearing arrangement according to the present invention, other forms of rolling elements are also applicable. Reference numeral 12 indicates conventional cages. The disclosed embodiment also shows that the bearing rings have integral races for the bearings. Separable races can also be used with the bearing rings.

As shown in FIG. 1, both rolling-contact bearings 2 and 4 can be axially staged or offset, but may also be arranged exactly concentric.

According to the present invention, the center bearing ring 3 is coupled to a planetary gear carrier 8, with the coupling being providable such that axial length compensation is offered.

The planetary gear carrier 8 holds, via planetary gear bearings 7, several planetary gears 9. Depending on the dimensioning of the axial bearing according to the present invention, an appropriate number of planetary gears 9 is provided.

The planetary gears 9 are in mesh with a ring gear 10, which is stationarily arranged on the outer bearing ring 1 or attached to the latter, and with a sun gear 6, which is anti-rotationally connected to the shaft 11. As the shaft, together with the sun gear 6, rotates relative to the ring gear 10, the planetary gears 9 perform a rolling motion, as typical of planetary gearing.

It is obvious that other inventive provisions in terms of dimensioning and/or design are applicable to set, in particular, the center bearing ring in positive motion (forced rotation) as the shaft rotates relative to the casing.

### List of Reference Numerals

1 Outer bearing ring

2 Radially outer rolling-contact bearing

3 Center bearing ring

4 Radially inner rolling-contact bearing

5 Inner bearing ring

6 Sun gear

7 Planetary gear bearing

8 Planetary gear carrier

9 Planetary gear

10 Ring gear

11 Shaft

12 Cage

What is claimed is:

1. An axial bearing comprising:
a radially inner rolling-contact bearing, the radially inner rolling-contact bearing comprising an inner bearing ring and a center bearing ring and
a radially outer rolling-contact bearing, the radially outer rolling-contact bearing also comprising the center bearing ring and further comprising an outer bearing ring and a positive-drive element for the center bearing ring.

2. The axial bearing of claim 1, wherein the positive-drive element is a mechanically active element.

3. The axial bearing of claim 2, wherein the positive-drive element is a planetary gear.

4. The axial bearing of claim 3, wherein the positive-drive element is arranged to act between the outer bearing ring, the center bearing ring and the inner bearing ring.

5. The axial bearing of claim 4, wherein the radially outer rolling-contact bearing and the radially inner rolling-contact bearing are of similar configuration.

6. The axial bearing of claim 4, wherein the radially outer rolling-contact bearing and the radially inner rolling-contact bearing are of different configuration.

7. The axial bearing of claim 4, wherein the radially outer rolling-contact bearing and the radially inner rolling-contact bearing are arranged concentrically relative to each other.

8. The axial bearing of claim 4, wherein the radially outer rolling-contact bearing and the radially inner rolling-contact bearing are axially offset relative to each other.

9. The axial bearing of claim 4, wherein the planetary gear comprises:
a sun gear, which is anti-rotationally connected to the inner bearing ring,
a planetary gear carrier, which is anti-rotationally connected to the center bearing ring,
a ring gear which is anti-rotationally connected to the outer bearing ring, and
a plurality of planetary gears which are in mesh with the sun gear and the ring gear.

10. The axial bearing of claim 9, wherein the radially outer bearing ring, the radially center bearing ring and the radially inner bearing ring are movable in a same direction of rotation.

11. The axial bearing of claim 9, wherein the radially outer bearing ring and the radially inner bearing ring are movable in a same direction of rotation, and in that the radially center bearing ring is movable in an opposite direction of rotation.

12. The axial bearing of claim 11, wherein essentially the same axial force is applied to the radially outer rolling-contact bearing and to the radially inner rolling-contact bearing.

13. The axial bearing of claim 1 used as thrust bearing for a gas turbine.

14. The axial bearing of claim 1, wherein the radially outer rolling-contact bearing and the radially inner rolling-contact bearing are of similar configuration.

15. The axial bearing of claim 1, wherein the radially outer rolling-contact bearing and the radially inner rolling-contact bearing are of different configuration.

16. The axial bearing of claim 1, wherein the radially outer rolling-contact bearing and the radially inner rolling-contact bearing are arranged concentrically relative to each other.

17. The axial bearing of claim 1, wherein the radially outer rolling-contact bearing and the radially inner rolling-contact bearing are axially offset relative to each other.

18. The axial bearing of claim 3, wherein the planetary gear comprises:
a sun gear, which is anti-rotationally connected to the inner bearing ring,
a planetary gear carrier, which is anti-rotationally connected to the center bearing ring,
a ring gear which is anti-rotationally connected to the outer bearing ring, and
a plurality of planetary gears which are in mesh with the sun gear and the ring gear.

19. The axial bearing of claim 18, wherein the radially outer bearing ring, the radially center bearing ring and the radially inner bearing ring are movable in a same direction of rotation.

20. The axial bearing of claim 18, wherein the radially outer bearing ring and the radially inner bearing ring are movable in a same direction of rotation, and in that the radially center bearing ring is movable in an opposite direction of rotation.
